(19) United States
(12) Patent Application Publication
(10) Pub. No.: US 2005/0050813 A1
(43) Pub. Date: Mar. 10, 2005

(54) Device and method for measuring windows

(76) Inventor: Angela McAree, Canton, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/654,713

(22) Filed: Sep. 4, 2003

(51) Int. Cl. E06B 3/00

(52) U.S. Cl. 52/204.5

(57) ABSTRACT

A trigonometric measuring device and method for obtaining measurements of palladium or arched windows, particularly in difficult positions, such as high places while standing upon a ladder, and for creating a template suitable for design and installation of window treatments.

### TECHNICAL FIELD

The present invention relates generally to an apparatus and method for measuring windows, more particularly palladium or arched windows, for design and installation of window treatments thereon.

### BACKGROUND OF THE INVENTION

When measuring windows located high above a floor surface, particularly palladium-style windows (also known as Palladian) or arched windows, it is necessary to climb a ladder and perform measurements. Typically, paper is taken up the ladder and attached to the window with pins, and then the designer must trace the window pattern outline on the paper. The paper is unwieldy, difficult to position, susceptible to tearing and generally difficult to work with effectively. The designer then returns to the floor surface and lays the tracing out on a second drawing surface in order to form a template for design of a window treatment or the like.

There are various measuring devices and methods available, but all are disadvantageous when compared to the present invention.

Some devices are trigonometrically based, such as protractors with or without pivoting arms to measure or draw an angle. Others utilize rulers for measuring distances between points and/or trammels for drawing elliptical arcs.

While some or all of the above-referenced devices may well be utilized for measuring, many are highly complicated and do not adequately provide a device suitably convenient or effective for measuring palladium or arched windows and for creating a template thereof.

### BRIEF SUMMARY OF THE INVENTION

Briefly described, in a preferred embodiment, the present invention overcomes the above-mentioned disadvantages and meets the recognized need for such a device by providing a method and apparatus for measuring palladium or arched windows in high places and for creating a template thereof suitable for use in the design and installation of window treatments.

According to its major aspects and broadly stated, the present invention in its preferred embodiment is a trigonometric measuring device for obtaining measurements of palladium or arched windows, particularly for difficult positions, such as while standing upon a ladder high above a floor.

A feature and advantage of the present invention is its ability to be securely pinned in place during use.

A feature and advantage of the present invention is that it is adjustable to fit a plurality of window widths.

A further feature and advantage of the present invention is its ability to measure circular arcs, ellipses, straight line areas and complex forms within the shape of the arch of a palladium window.

A feature and advantage of the present invention is that it utilizes trigonometric principles for measurement.

A further feature and advantage of the present invention is its ease of manufacture and low cost of production.

A further feature and advantage of the present invention is its ability to create templates simply and easily.

A feature and advantage of the present invention is its ability to measure a variety of different sized window arches.

An additional feature and advantage of the present invention is its ability to measure complex arches.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, which are not necessarily drawn to scale, and in which like reference numerals denote similar structures and refer to like elements throughout, and in which:

FIG. 1A is a plan view of a device according to a preferred embodiment of the present invention.

FIG. 1B is a top view of a device according to a preferred embodiment of the present invention with ruler over center nub.

FIG. 1C is a callout view of the device of FIG. 1B according to a preferred embodiment of the present invention, with ruler in position over a nub.

FIG. 1D is a partial top view taken of the device of FIG. 1A, from viewpoint A, according to a preferred embodiment of the present invention, with ruler between nubs.

FIG. 2 is a plan view of the device of FIG. 1A according to a preferred embodiment of the present invention, showing the device in use.

FIG. 3 is a plan view of a template drawn using the device of FIG. 1A according to a preferred embodiment of the present invention.

### DETAILED DESCRIPTION OF THE PREFERRED AND ALTERNATIVE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

The present invention is suitable for measuring and creating a pattern from objects having complex curvature, such as arched windows, including palladium windows, wherein the arch may be of any complex form. Using the device of the present invention, an operator can quickly and easily take measurements of an arched window and transfer them to a template for use in making window treatments for the measured window.

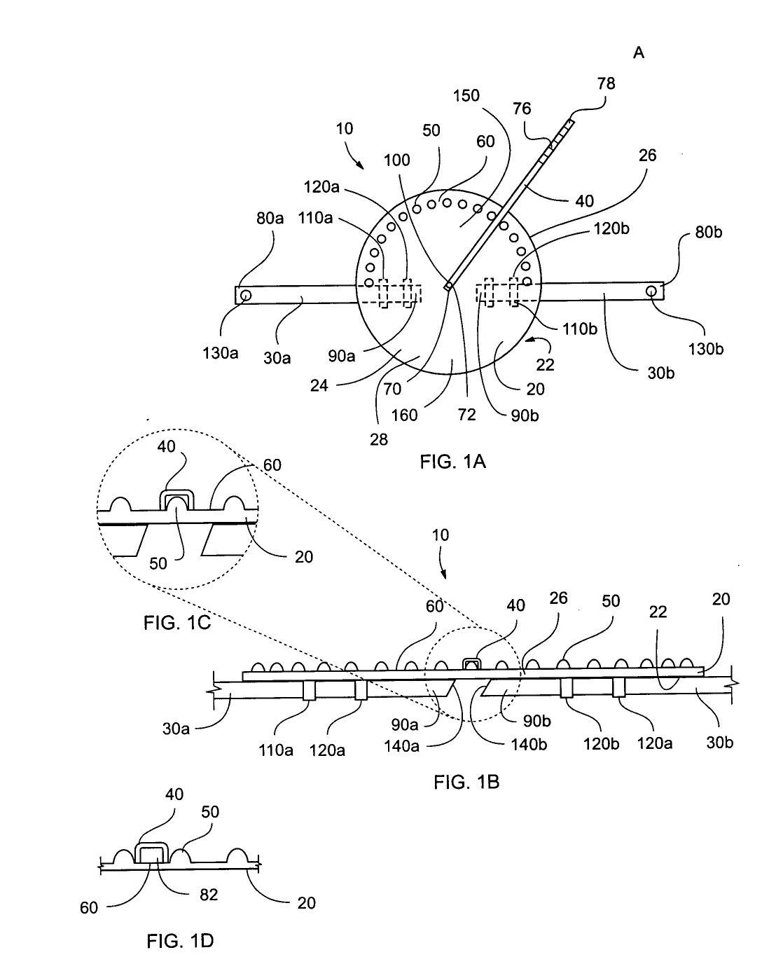

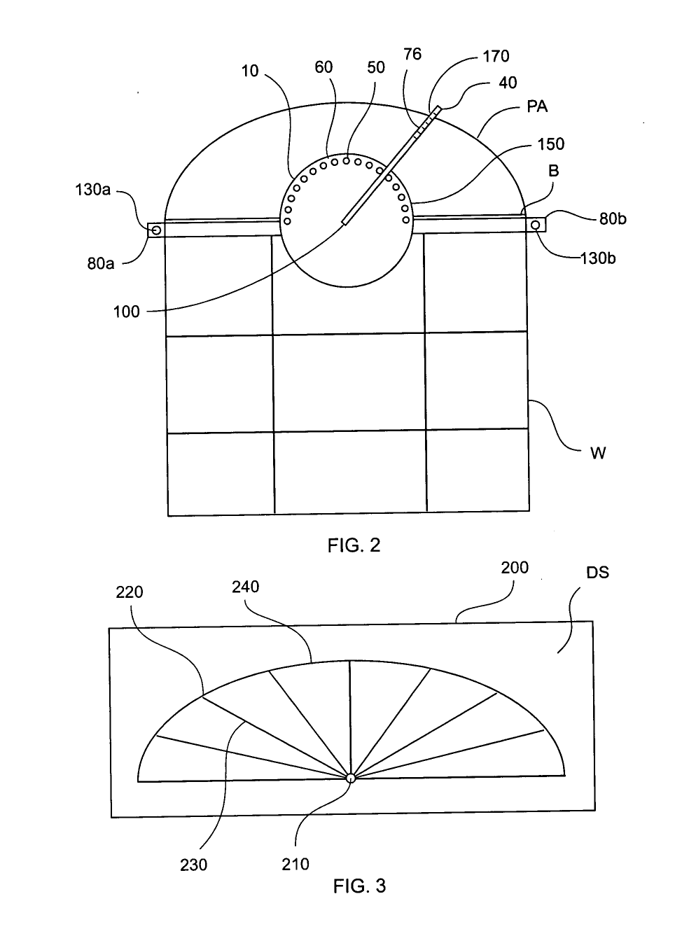

Referring now to FIGS. 1A through 1D, apparatus 10 is a device for measuring palladium or arch windows. Apparatus 10 preferably has circular disc base 20, preferably having center point 100 preferably located at the center of circular disc base 20. Circular disc base 20 preferably has top semicircular portion 150 and bottom semicircular portion 160. Moveable arm or rotating ruler 40 is preferably swivelably mounted proximate to center point 100 of circular disc base 20. Projections or nubs 50 are preferably defined on first surface 24 of circular disc base 20, preferably proximate to peripheral edge 26 of top semicircular portion 150, wherein the plurality of projections or nubs 50 are preferably defined with spaces 60 therebetween. Nubs 50 are preferably equally spaced, at approximately ten-degree intervals, preferably defining an arc of one hundred-and-eighty degrees, preferably proximate to the periphery edge 26 of top semicircular portion 150. Bottom semicircular portion 160 preferably serves as a user handgrip area to facilitate holding and placing of apparatus 10 in position at base B (as best seen in FIG. 2) of an arc of a window to be measured.

First end 70 of rotating ruler 40 is preferably swivelably attached to circular disc base 20, preferably at center point 100. Attachment of rotating ruler 40 is preferably accomplished via any attachment means allowing generally free rotational movement, such as, for exemplary purposes only, rivet 72, wherein rivet 72 preferably permits rotating ruler 40 to pivotally swing about center point 100. Second end 78 of rotating ruler 40 preferably has gradations 76 thereon, wherein gradations 76 are preferably marked in measurement units, such as, for exemplary purposes only, inches and/or feet, and/or centimeters and/or meters. Rotating ruler 40 is preferably capable of a plurality of positions wherein a first position is over nubs 50, with rotating ruler 40 being retained on nubs 50, such as to preferably prevent further movement of rotating ruler 40, and a second positions is in spaces 60 between nubs 50, also to prevent further movement of rotating ruler 40.

Extension legs or bars 30a and 30b are preferably positioned on reverse side 22 of circular disc base 20 and are preferably slidably attached thereto. Extension bars 30a and 30b are preferably operated independently of one another. Extension bar 30a is preferably slidably supported proximate to second side 22 of circular disc base 20 preferably via braces 110a and 120a. Extension bar 30b is preferably slidably supported proximate to second side 22 of circular disc base 20 preferably via braces 110b and 120b.

Pushpin 130a is preferably positioned proximate to first end 80a of extension bar 30a, wherein pushpin 130a is preferably suitable for removably securing apparatus 10 to a wall, window frame or other structure. Extension bar 30a preferably extends under brace 110a and brace 120a, preferably supported thereby. Extension bar 30a may thus preferably be slidably moved to position first end 80a at a plurality of selectable positions relative to the distance from center point 100.

Pushpin 130b is preferably positioned proximate to first end 80b of extension bar 30b, wherein pushpin 130b is preferably suitable for removably securing apparatus 10 to a wall, window frame or other structure. Extension bar 30b preferably extends under brace 110b and brace 120b, preferably supported thereby. Extension bar 30b may thus preferably be slidably moved to position first end 80b at a plurality of selectable positions relative to the distance from center point 100.

Extension bar 30a preferably has chamfered edge 140a located at second end 90a. Extension bar 30b preferably has chamfered edge 140b located at second end 90b. Chamfered edge 140a and 140b of extension bars 30a and 30b, respectively, enable cooperative positioning of extension bars 30a and 30b, such as would be suitable during storage or when measuring a narrow window, wherein extension bars 30a and 30b are preferably capable of slidably compacting within peripheral edge 26 of circular disc base 20. Alternately, when greater expansion or width is desired, such as to measure a wider window, extension bars 30a and 30b can be slidably extended to the desired width.

In order to design and prepare window treatments for arch or palladium windows, it is necessary to have a pattern that duplicates the size and shape of the window to be so adorned. Thus it is necessary to first obtain measurements and then to transfer the measurements to a template.

Turning now to FIG. 2, in order to obtain measurements, apparatus 10 is preferably placed along base B of arch PA of a palladium or arch window W in such fashion that center point 100 preferably lies on base B of arch PA. Once in position, apparatus 10 is preferably removably secured in place preferably via push pins 130a and 130b, preferably located at first end 80a of extension bar 30a and first end 80b of extension bar 30b, respectively. Once apparatus 10 is properly positioned and secured relative to window W, rotating ruler 40 is preferably placed over each nub 50 and in each space 60 between nubs 50, preferably in sequential order. In each such position, distance 170 to arch PA is preferably noted with reference to gradations 76 on rotating ruler 40 and preferably recorded for subsequent use during the template preparation phase. After recording distances 170 to arch PA for each nub 50 and space 60 located around the top semicircular portion 150 of apparatus 10, apparatus 10 is removed from window W.

Preferably, distances measured for each nub 50 and space 60 are recorded on first surface 24 of circular disc base 20. First surface 24 has material 28 attached thereon permitting erasing of notations made thereon. In an alternative embodiment, a pad of paper may be attached to first surface 24 for notation of distances measured. In another alternative embodiment, a device capable of entering and memorizing, such as an electronic storage calculator, may be attached to first surface 24 for recording distances measured. In yet another alternative embodiment, apparatus 10 could include a recording means that automatically takes and stores the distances for each position of rotating ruler 40, wherein the distance stored is determined by a sliding measurement indicator located on rotating ruler 40.

In order to produce template 200 such as shown in FIG. 3, apparatus 10 is preferably placed upon a suitable drawing surface DS. Apparatus 10 is then preferably placed or fixed by pinning, or other means, in position and rotating ruler 40 is once again preferably moved to each nub 50 and each space 60 between nubs 50, and each distance 170 previously recorded is then preferably marked with reference to gradations 76 on rotating ruler 40.

An exemplar of a resulting template 200 with the arch perimeter 240 drawn thereon is shown in FIG. 3. Previously recorded measurements of distances or lengths 230 from center point 210 to arch perimeter 240 are each located using rotating ruler 40 and gradations 76 thereon, points or other notational markings 220 are placed on template 200, wherein connecting lines are drawn between points 220 to form arch perimeter 240. In such fashion, template 200 may be suitably and accurately produced.

Apparatus 10 may be constructed in the major part of any suitable material, such as, for exemplary purposes only, plastic sheet, metal or wood. Various rotational fasteners may be used as appropriate, such as, for exemplary purposes only, rivet or pin 72.

It is envisioned in an alternative embodiment that apparatus 10 may be constructed principally of cardboard.

It is contemplated in an alternative embodiment that rotating ruler 40 may be extendible, such as, for exemplary purposes only, by telescoping.

It is further contemplated that the device of the present invention may be used to measure and design windows, or any other appropriately shaped items, in addition to window treatments.

It is further envisioned that extendible legs 30a and 30b could include telescopically-related section(s).

It is also contemplated that the device of the present invention could be fixed in place by extension of telescopically extendible legs.

In yet another embodiment, it is envisioned that extendible legs 30a and 30b may be hinged such that they may be folded.

The foregoing description and drawings comprise illustrative preferred and alternate embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not necessarily constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. A device for measuring comprising:
at least one moveable arm;
at least one base; and
means for attaching said at least one moveable arm to said at least one base.

2. The device of claim 1, further comprising at least one leg attached to said at least one base.

3. The device of claim 2, wherein said at least one leg is extendible.

4. The device of claim 2, wherein said at least one leg comprises two opposingly-positioned, extendible legs.

5. The device of claim 1, further comprising mounting means for removably affixing said device proximate to the object to be measured.

6. The device of claim 5, wherein said mounting means comprises pins.

7. The device of claim 1, wherein said at least one base has a generally disc-like shape comprised of semicircular top portion and semicircular bottom portion.

8. The device of claim 7, further comprising a plurality of projections carried on a first surface of said semicircular top portion of said at least one base, proximate to the peripheral edge of said semicircular top portion.

9. The device of claim 1, wherein said means for attaching comprises a pivot.

10. The device of claim 1, wherein said at least one moveable arm carries gradations thereon, wherein the position of said gradations defines measurement units.

11. The device of claim 8, wherein said at least one moveable arm comprises a locking surface, wherein said locking surface is defined proximate to said first surface of said base, and wherein said locking surface is dimensioned to receive and retain one of said plurality of projections.

12. The device of claim 8, wherein a plurality of receiving areas are defined between each pair of said plurality of projections, wherein each receiving area of said plurality of receiving areas is at least the width of said at least one moveable arm, whereby said at least one moveable arm may be positioned between each said pair of projections.

13. The device of claim 3, wherein said at least one extendible leg comprises two extendible legs, wherein said two extendible legs overlap one another when in closed position.

14. A method for measuring windows comprising the steps of:
a) obtaining at least one measuring device comprising a base with at least one pivoting arm and a means for radially incrementing said at least one pivoting arm;
b) aligning said at least one measuring device with a reference point of a window;
c) measuring a desired distance via said at least one pivoting arm; and
d) repeating step c) for various incremental positions of said at least one pivoting arm.

15. The method of claim 14, wherein said means for radially incrementing comprises a plurality of projections on said base.

16. The method of claim 14, further comprising the step of:
c′) recording said desired distance measured.

17. The method of claim 15, further comprising the step of:
b′) positioning said at least one pivoting arm between a first pair of said plurality of projections.

18. The method of claim 14, wherein said at least one measuring device further comprises extendible cross-supports.

19. The method of claim 18, further comprising the step:
a′) extending said extendible cross-supports.

20. The method of claim 19, further comprising the step of″
a″) positioning said extendible cross-supports in alignment with the window.

21. A method for making a template comprising the steps of:
a) obtaining a measuring device having a base with at least one pivoting arm, and a means for radially incrementing said at least one pivoting arm;
b) obtaining stock for use in making the template;
c) positioning said measuring device proximate to said stock; and
d) marking previously recorded distances on said stock for various incremental positions of said at least one pivoting arm.

22. The method of claim 21, wherein said at least one measuring device further comprises at least one extending arm.

23. The method of claim 22, further comprising the steps of:
c′) extending said at least one extending arm; and
c″) marking a line along said at least one extending arm.

24. The method of claim 21, wherein said means for radially incrementing comprises a plurality of projections on said base.
